(19) United States
(12) Patent Application Publication
(10) Pub. No.: US 2024/0160431 A1
(43) Pub. Date: May 16, 2024

(54) TECHNOLOGIES TO UPDATE FIRMWARE AND MICROCODE

(71) Applicant: Intel Corporation, Santa Clara, CA (US)

(72) Inventors: Mohan J. KUMAR, Aloha, OR (US); Murugasamy K. NACHIMUTHU, Beaverton, OR (US); Daniel K. OSAWA, Tigard, OR (US); Maciej PLUCINSKI, Tigard, OR (US); Avinash CHANDRASEKARAN, Mountain View, CA (US)

(21) Appl. No.: 18/391,637

(22) Filed: Dec. 20, 2023

Related U.S. Application Data
(60) Provisional application No. 63/544,527, filed on Oct. 17, 2023.
(60) Provisional application No. 63/544,426, filed on Oct. 16, 2023.

(51) Int. Cl. G06F 8/65; G06F 9/4401

(52) U.S. Cl. CPC G06F 8/65; G06F 9/4401

(57) ABSTRACT

Examples described herein relate to updating boot firmware code or microcode. In some examples, a management controller includes a memory and a system processor, coupled to the management controller, is to: based on a first configuration, perform a boot operation by a read of first boot firmware code from the memory of the management controller. Based on a second configuration, the system processor is to perform a boot operation by a read of second boot firmware code from a flash memory.

### RELATED APPLICATION

This application claims priority to U.S. Provisional Application No. 63/544,426, filed Oct. 16, 2023 and U.S. Provisional Application No. 63/544,527, filed Oct. 17, 2023. The entire contents of those applications are incorporated by reference in their entirety.

### BACKGROUND

When a computer starts up, the system executes a boot firmware to check a predetermined list of devices to identify a storage location of an operating system (OS) that is to be executed. FIG. 1 depicts a prior art example of boot from a flash device. A central processing unit (CPU) socket can fetch a Basic Input/Output System (BIOS) from a boot storage device using an interface that operates in a manner consistent with Serial Peripheral Interface (SPI). System boot (e.g., server boot) has been based on the ability of the CPU to access the BIOS image from the BIOS flash device.

### BRIEF DESCRIPTION OF THE DRAWINGS

FIG. 1 depicts an example network interface device.

FIG. 2 depicts an example of boot image loading from a memory of a management controller.

FIG. 3 depicts an example manner to load a firmware image from an image server into management controller memory.

FIG. 4 depicts an example of an image server communicating with one or more management controllers.

FIG. 5 shows a prior art system with host flash containing BIOS and microcode.

FIG. 6 shows a system in which BIOS and microcode images are hosted in memory of a management controller.

FIG. 7A shows a system with the microcode update flow.

FIG. 7B shows a system with the microcode update flow.

FIG. 7C shows a system with the microcode update flow.

FIG. 7D shows a system that performs microcode updating.

FIG. 8A depicts an example process.

FIG. 8B depicts an example process.

FIG. 9 depicts an example system.

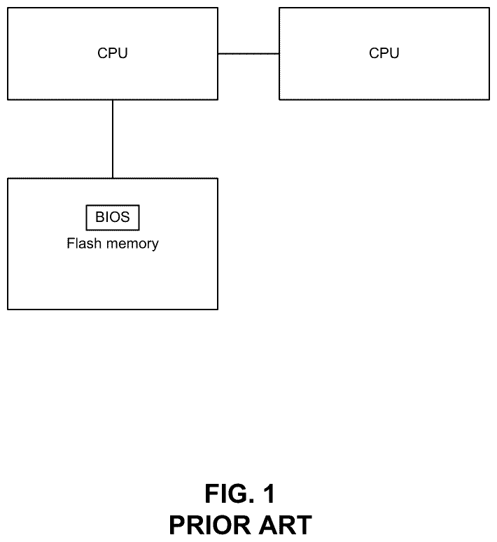

### DETAILED DESCRIPTION

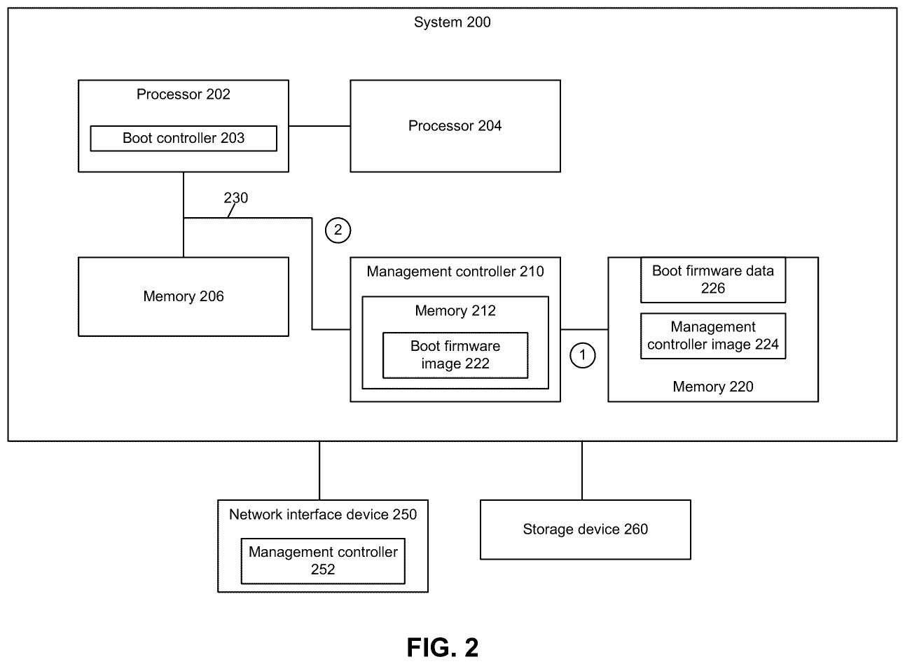

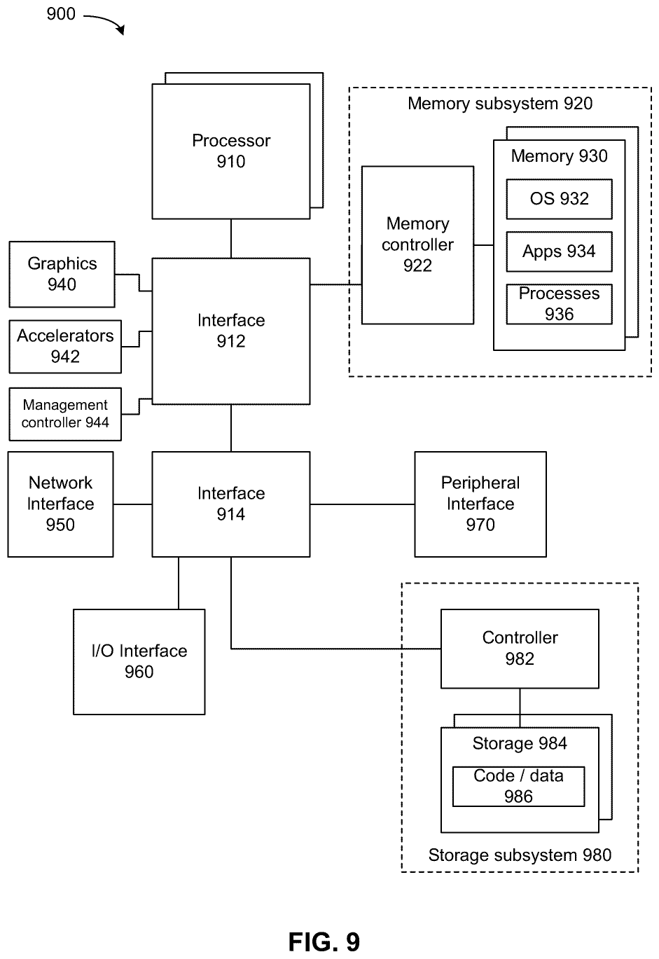

Various examples allow a CPU or processor in a server platform or network interface device to boot from boot code by loading boot code from memory of a management controller, instead of loading the boot code from a flash memory. FIG. 2 depicts an example of boot image loading from a memory of a management controller by a system. Various examples of server platform 200 of FIG. 2 can include circuitry and/or software described with respect to FIG. 9. One or more of system processors 202 and 204 can include: a CPU; a programmable packet processing pipeline; an accelerator; an application specific integrated circuit (ASIC); a field programmable gate array (FPGA); a graphics processing unit (GPU); a memory device; or other circuitry. As described herein, at least at start up or reboot of a server system, one or more of system processors 202 and 204 can load a boot firmware image from memory 212 of management controller 210.

Management controller 210 can perform management and monitoring capabilities for system administrators to monitor operation at least of host 200 and devices connected thereto, such as, network interface device 250 and storage device 260, using channels, including channels that can communicate data (e.g., in-band channels) and out-of-band channels. Out-of-band channels can include packet flows or transmission media that communicate metadata and telemetry and may not communicate data. In some examples, management controller 210 can be implemented as one or more of: Board Management Controller (BMC), Intel® Management or Manageability Engine (ME), or other devices.

In some examples, boot controller 203 can be implemented using a CPU core or a thread of a multi-threaded core. Boot controller 203 can load boot firmware image 222 from memory 212 of management controller 210. In some examples, boot controller 203 can be coupled to memory 212 using interface 230. Interface 230 can provide communication using one or more of the following protocols: Improved Inter Integrated Circuit (I3C), Universal Serial Bus Type-C (USB-C), serial peripheral interface (SPI), enhanced SPI (eSPI), System Management Bus (SMBus), I2C, MIPI I3C®, Peripheral Component Interconnect Express (PCIe), Compute Express Link (CXL). See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof.

An example of operation to access boot firmware image 222 is as follows. At (1), boot image 222 can be stored into management controller memory 212 from memory 220 or an image server, as described herein. At (2), based on a configuration, system processor 202 can access boot image 222, that would have otherwise been stored in memory 206, from memory 212. Management controller 210 can be configured so that, in store and forward (SAF) mode, eSPI interface cycles are redirected to access boot firmware image 222 in management controller memory 212, instead of memory 206. Platform reset can be released to allow processor 202 to fetch boot firmware image 222 from management controller memory 212 and boot.

Management controller 210 can execute management controller image 224 from memory 220 at boot. Management controller image 224 can cause performance of management features such as: temperature monitor, monitor and control fan speed, telemetry, reboot commands, or others.

Boot firmware data 226 can store system configurations that are to be persistent, such as hyperthreading mode or other boot firmware variables. Accordingly, boot firmware data 226 can be stored in non-volatile memory.

In some examples, boot firmware image 222 or firmware can include one or more of: microcode (ucode), Basic Input/Output System (BIOS), Universal Extensible Firmware Interface (UEFI), a boot loader, an operating system (OS), Authenticated Code Modules (ACM) such as Boot Guard ACM, or others. The BIOS firmware can be pre-installed on a personal computer's system board or accessible through an SPI interface from a boot storage (e.g., flash memory). In some examples, firmware can include SPS. In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an System Management Module (SMM) image via existing OS specific techniques (e.g., Windows Update for Azure, or LVFS for Linux). In some example, SMM can be part of CPU and/or memory.

Examples described with respect to management controller 210 can apply to management controller 252 in network interface device 250, in some examples. In some examples, network interface device 250 can refer to one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth).

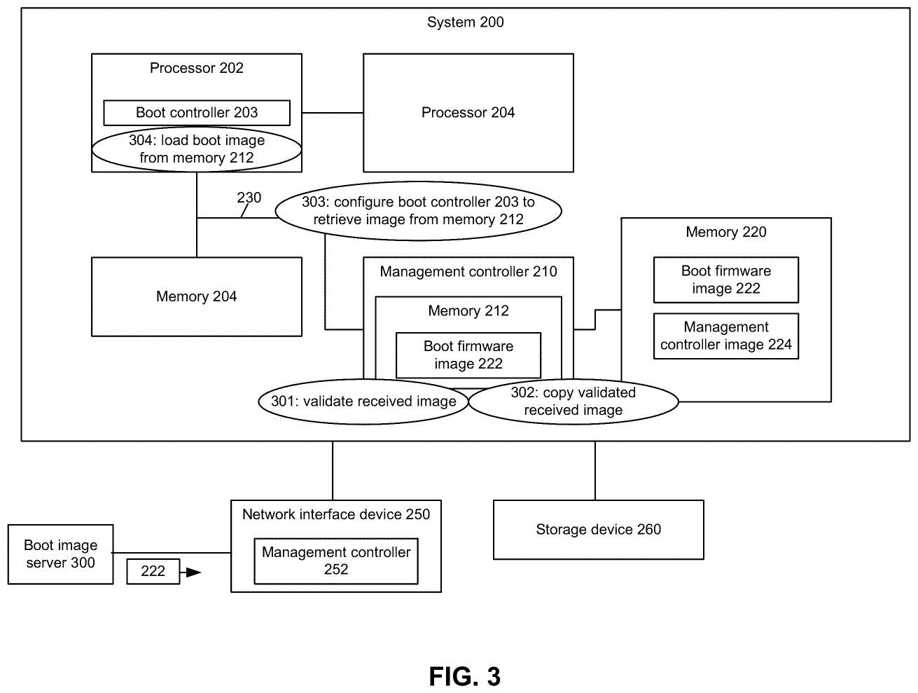

FIG. 3 depicts an example manner to load a firmware image from an image server into management controller memory. Boot image server 300 can communicate with management controller 210 via network interface device 250 to store boot image 222 into memory 212 of management controller 210. Management controller 210 could be configured with network address and credentials of boot image server 300 and management controller 210 could read image 222 from boot image server 300. In some examples, an orchestrator can poll for readiness of management controller 210 to receive image 222 and can cause boot image server 300 to transmit image 222 to management controller 210 for storage in memory 212.

On receiving image 222, management controller 210 can perform the following operations. At 301, management controller 210 can validate the received image 222. Validation of received image 222 can be based on use of public-private keys, determination of whether an integrity check value (e.g., cyclic redundancy check (CRC) or checksum) received in image 222 matches an expected value, or other techniques. Based on failure to validate image 222, the image can be discarded, an error message indicated, or a retransmission of image 222 can be requested. At 302, based on validation of image 222, image 222 can be copied to a location in an address range in memory 212 of management controller 210. The address range (e.g., Address Range A) can be allocated for storage of boot images in memory 212. At 303, management controller 210 can apply a configuration whereby accesses via interface 230 from boot processor 203 can be sent to Address Range A allocated for boot firmware image 222.

At 304, boot controller 203 can be configured to access boot firmware image 222 from Address Range A in memory 212, instead of from memory 206. For example, a customer or manufacturer can configure boot controller 203 can be configured to access boot firmware image 222 from Address Range A in memory 212, instead of from memory 206. For example, operation 304 can include: assertion of Processor Reset, programming a general-purpose input/output (GPIO) pin so that boot controller 203 is set in eSPI Device Attached Flash (eDAF) mode to access host flash, and release of Processor Reset state. In some examples, processor accesses can be automatically routed by management controller 210 to memory Address Range A in memory 212 of management controller 210, instead of memory 206 (e.g., flash memory or non-volatile memory), allowing the host system to boot without a flash device (e.g. memory 204).

In some examples, configuration of boot controller 203 to access boot firmware image 222 from Address Range A in memory 212, instead of from memory 206 in operation 304 can be as follows. At 304.1, a hardware selectable option (e.g., platform jumper) to forward flash address range accesses to memory 212 in a processor socket of processor 202 can be set. At 304.2, firmware executing on management controller 210 can initialize management controller 210 by allocating Address Range A to store a boot image copied from a region in storage 220 and received from boot image server 300, or allocating part of the BIOS flash space in memory 206 to store a boot image copied from a region in storage 220 and received from boot image server 300.

In some examples, in operation 304, during the firmware provisioning or using GPIO or hardware (HW) straps, management controller 210 could be configured to access boot firmware image 222 from memory 206 and forward the accessed boot firmware image 222 to processor 202 or provide boot firmware image 222 from memory 212 to processor 202. In some examples, management controller 210 could provide boot firmware for multiple host systems (e.g., multiple different boot processors) at a time.

Advantages of booting from memory of management controller instead of flash can include: reduced Platform Bill of Materials (BOM) cost by eliminating a flash device and its protection circuitry, reduced time to perform BIOS image updates as no erase cycles are needed for updating memory of a management controller, management controller memory is not subject to wear out or flash attacks, management controller can act as a sole arbitrator for runtime BIOS variable write thus eliminating the host versus platform contention during boot image updating, or consolidation of Platform Root of Trust in management controller for boot image validation and validation of data in flash memory.

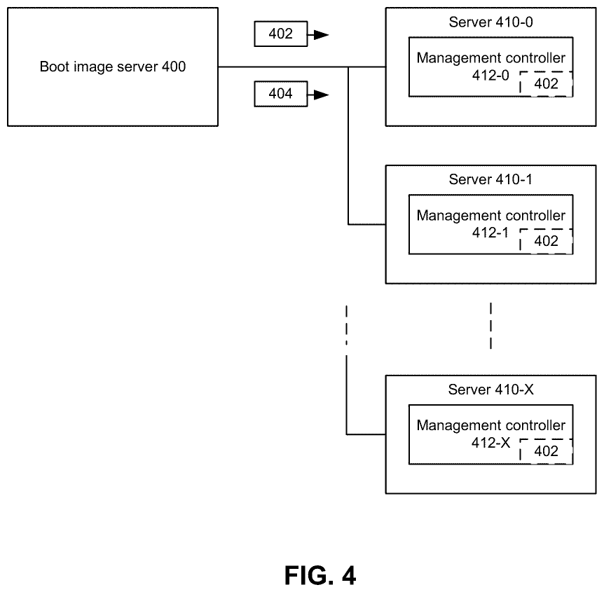

FIG. 4 depicts an example of an image server communicating with one or more management controllers. Boot firmware image server 400 can be connected to servers 410-1 to 410-X, where X is an integer, via a network. Boot firmware image server 400 can communicate with servers 410-1 to 410-X in a secure manner (e.g., encrypted communications). In some examples, server 400 can transmit image 402 as a multipart HTTP Push request in accordance with section 7.2 (The Multipart Content-Type), RFC 1341 (1992). For example, boot firmware image server 400 can configure one or more of management controllers 412-0 to 412-X so that loading of boot firmware 402 by a boot controller occurs from a memory of management controller.

For example, boot firmware image server 400 can execute an example script for a given boot image 402.

For Target Server i = 1 ... X
Perform Push update of Image 402 to Target Server i
End For Loop

For example, boot firmware image server 400 can transmit a script 404 (e.g., configuration or instructions) to configure one or more of management controllers 412-0 to 412-X and associated boot controllers.

An example script sent to target servers using Redfish Multipart HTTP to store boot firmware 402 into memory of a management controller can be as follows:

POST /redfish/v1/UpdateService/update-multipart HTTP/1.1
Content-Type: multipart/form-data; boundary=---------------------------d74496d66958873e
Content-Length: ---------------------------d74496d66958873e
Content-Disposition: form-data; name=“UpdateParameters”
Content-Type: application/json { } ---------------------------d74496d66958873e
Content-Disposition: form-data; name=“UpdateFile”; filename=“bios_update.bin”
Content-Type: application/octet-stream
Content of BIOS image binary ... // content of image file

### Microcode Updates

Microcode can include a set of hardware-level instructions that implement machine code instructions or control internal finite-state machine sequencing of digital processing components. Microcode can provide an intermediary layer between CPU hardware and the instruction set architecture of the CPU. Server systems can boot with processor and/or system on chip (SOC) firmware (FW), which can include unified microcode. Microcode can be integrated into Integrated Firmware Image (IFWI) along with system BIOS.

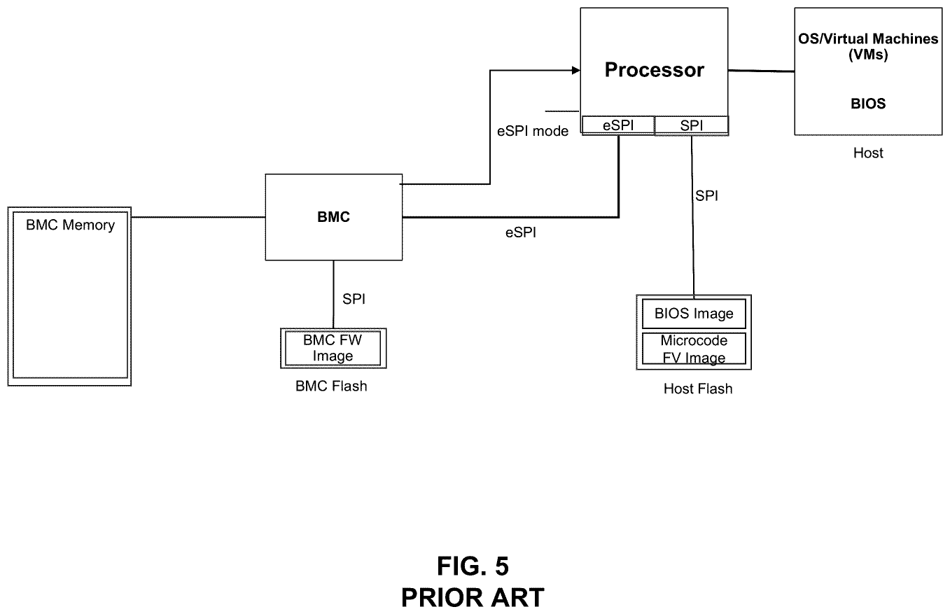

FIG. 5 shows a prior art system with host flash containing BIOS and microcode. On Intel® platforms, microcode updates can occur through OS kernel drivers and OS agents by copying microcode copy to OS memory and invoking Model Specific Register (MSR) 0x79. On bare-metal systems (e.g., computer servers used by one consumer, or tenant, only), customers execute customer-specific OSes and are to provide an OS agent (e.g., CPU monitoring agent) to update microcode. Hence, customer-vendor coordination is needed to update microcode to perform bug fixes, security fixes, or performance updates.

Microcode can be loaded: (1) at system boot or system reset, (2) when the OS boots, or (3) when OS is running. A microcode update deployed with a BIOS can involve a system reset or kernel reset, which can disrupt operation of the system. An OS scheduler timeout can occur when the microcode is not staged within the SOC before activating the microcode.

Various examples remove the need to utilize an in-band OS agents or CPU reset to deploy microcode updates or microcode rollback. Some examples provide a microcode update staging technology to copy microcode to a system on chip (SoC) using in-band PCIe Data Object Exchange (DOE) mailbox and authenticate microcode before activating the microcode. Various examples allow server platform to stage the microcode in flash or other memory, stage microcode to an SOC using a management controller, and activate the microcode through signaling an interrupt (e.g., System Management Interrupt (SMI)) to cause a write to a model specific register (MSR) or register with an address of the microcode in the management controller memory or other memory or storage to trigger execution of the microcode by a processor. Microcode update/rollback compatibility checks are performed within the management controller before activation of the microcode. Thus, in some examples, an OS agent is not used to update microcode (either update or rollback), however OS agents can be used to update microcode.

For example, first boot firmware code can include microcode to be executed by the processor and the processor is to fetch the microcode before the processor is to invoke code at a reset vector location. The reset vector can include a default location a CPU is to read to find the first instruction it will execute after a reset. The reset vector can be implemented as a pointer or address, where the CPU is to begin to execute instructions. The address can be in a section of non-volatile memory initialized to contain instructions to start the operation of the CPU, at boot of the system containing the CPU.

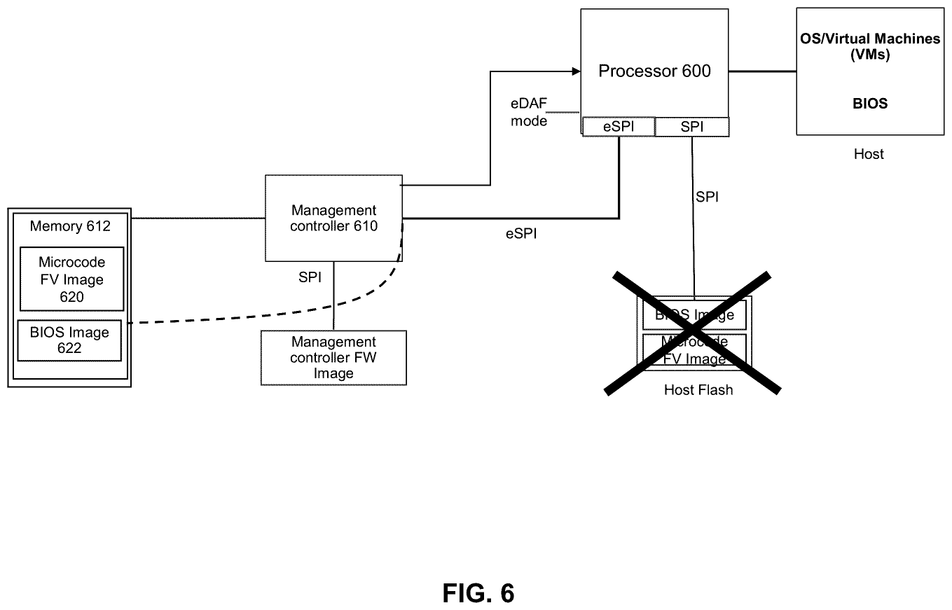

FIG. 6 shows a system that can perform operations for boot firmware updates or rollbacks with microcode updates or rollbacks. System boot firmware Intel® FirmWare Image (IFWI), or firmware utilized by processor designers such as ARM®, Advanced Micro Devices, Inc. (AMD)®, or others, can include microcode, BIOS and Authenticated Code Modules (ACM) such as Boot Guard ACM. On reset, processor 600 can fetch the microcode from a location pointed to by Firmware Interface Table (FIT) in memory 612 of management controller memory 610, authenticate microcode 620, execute microcode 620 and gives control to ACM to load the BIOS image 622 to boot. When a microcode is released, the platform vendor can integrate the microcode into the IFWI, update the IFWI, and reset the system to boot.

Traditionally, system boots occur from dedicated attached SPI flash. Using eSPI Device Attached Flash (eDAF) mode, host flash access could be redirected to memory 612 of management controller 610 to load boot firmware or microcode. Management controller 610 can intercept eSPI transactions and provide access to memory 612 of management controller 610. Some examples provide an opportunity to reduce flash cost by utilizing memory 612 of management controller 610 to store boot firmware or microcode.

If an updated microcode is released, that does not require reboot take effect and no BIOS changes are required, the microcode could be loaded through an OS. To load microcode through an OS, an OS agent copies the microcode to OS memory, rendezvous the processors, and invokes MSR 0x79 (or other memory address or register) with address pointing to the microcode location in memory to give control to the processor to authenticate and activate the microcode. If the processor supports microcode update staging mechanism, the processor reports such capability to the OS and the OS could make use of the microcode update staging interface to stage the microcode before activating the microcode.

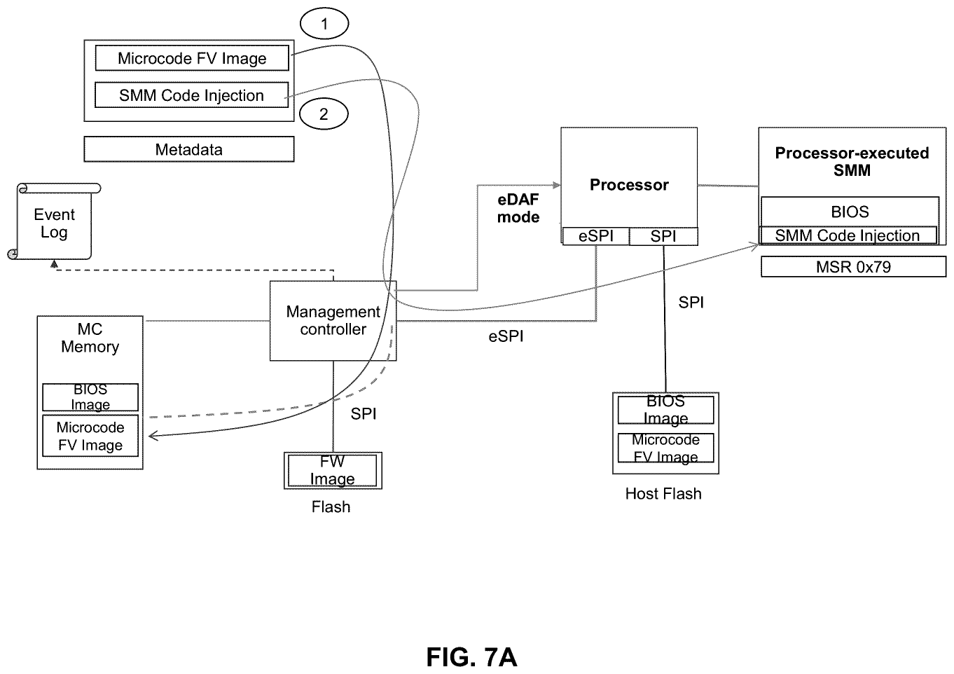

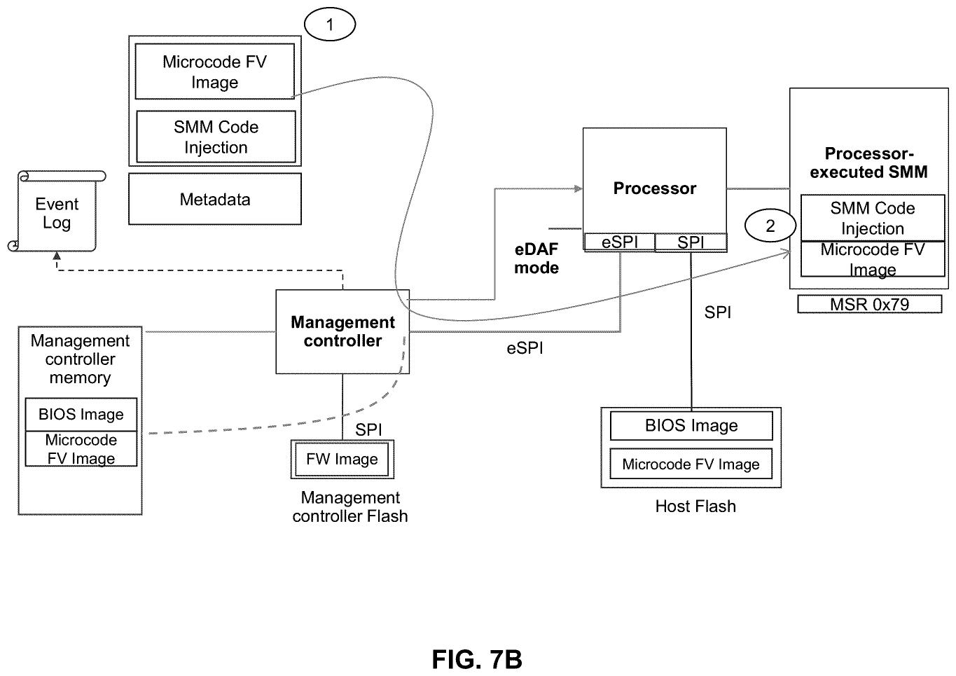

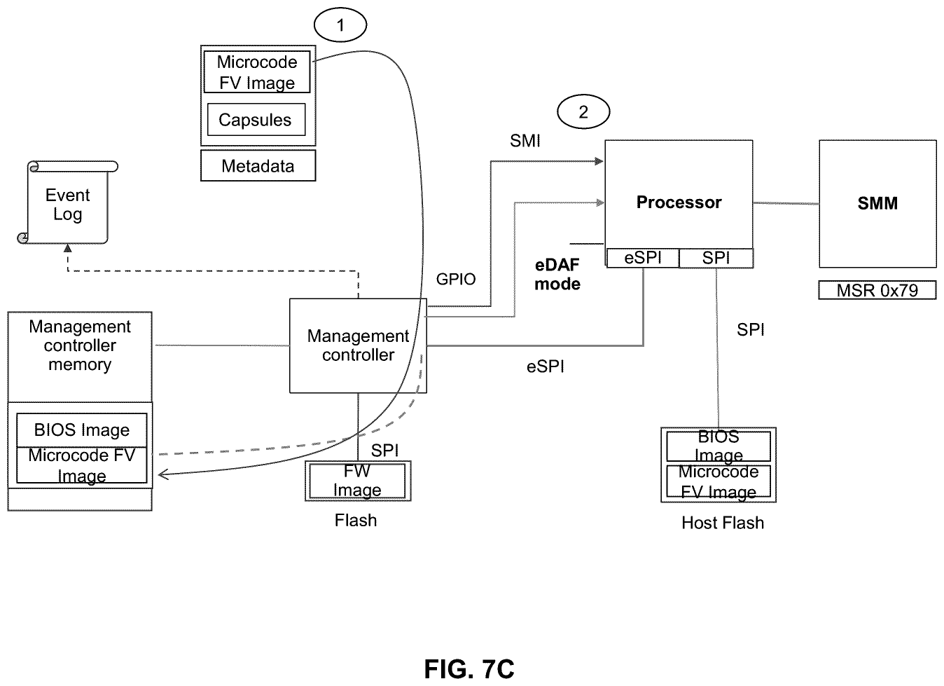

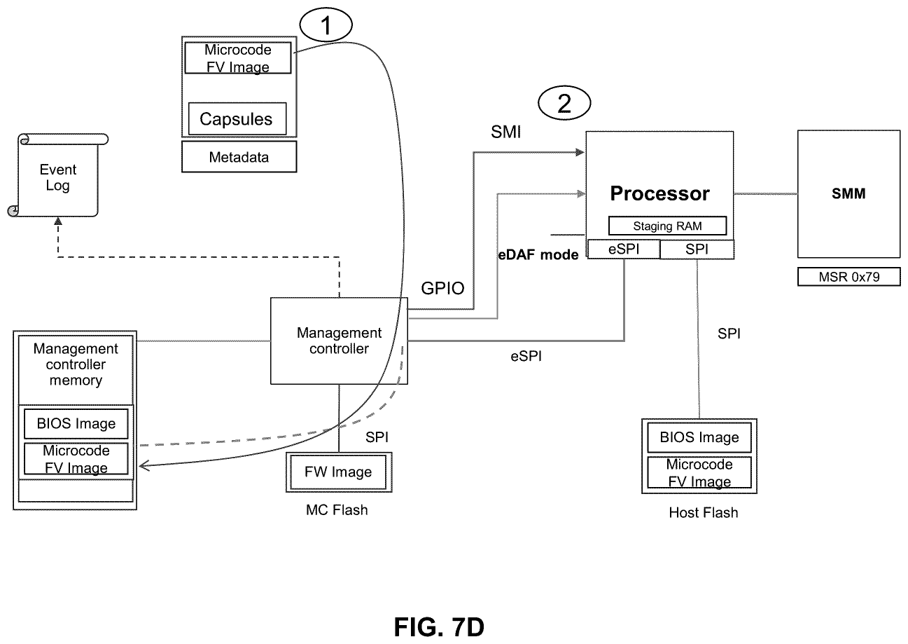

FIG. 7A shows a system with microcode update flow. In operation 1, an administrator or orchestrator can provide microcode capsule along with meta-data to the management controller. The management controller can authenticate the meta-data (e.g., target platform information, family, models, versions, etc.) to verify the microcode capsule is to be written to the target platform. Based on authentication of the meta-data, the management controller can copy the image to an IFWI Microcode region in management controller memory or host flash. In some examples, microcode can be written to management controller memory or host flash while a system is running with no system down time during these writes.

In operation 2, the SMM code injection capsule (e.g., a driver) along with meta-data can be provided by an administrator or orchestrator to management controller. Management controller can verify the meta-data associated with the SMM code injection capsule (e.g., target platform information, family, models, versions, etc.) to verify the SMM code injection capsule is to be written to the target platform. If verified, the management controller can copy the SMM code injection capsule to the processor-executed SMM through Memory-Mapped BMC Interface (MMBI), input/output (I/O), or memory interface and trigger an SMI. The SMM can be implemented as a processor-executed operating mode for handling system operations including power management, hardware control, or proprietary designed code. The SMM can be entered through an SMI or other interrupt and utilized by firmware (e.g., boot firmware image). An SMM can operate as a root of trust and authenticate the SMM code injection capsule and if the authentication passes, the processor-executed SMM can execute the SMM code injection module.

In some examples, execution of SMM code injection capsule causes a write to MSR 0x79 (or other register or a memory region) with an address pointing to an address of the microcode capsule (e.g., microcode firmware volume (FV) image) in memory of the management controller or host flash memory. In response to writing to the register, the processor can execute the microcode without an OS agent deploying the microcode. If a microcode rollback is to be performed, operations 1 and 2 can be repeated with the microcode containing the rollback version of the microcode.

During operations 1 and 2, management controller can update an event log with a status of activities. For example, activities can include: indicate microcode image received, authentication of microcode image (pass/fail), verification of SMM code injection capsule (pass/fail), staging of microcode image, execution of microcode image, etc.

FIG. 7B shows a system with the microcode update flow. In operation 1, an administrator or orchestrator can copy SMM code injection capsule, which includes microcode (e.g., update or rollback), to the management controller. The management controller can verify the SMM code injection capsule meta-data (e.g., target platform information, family, models, versions, etc.) to verify the SMM code injection capsule is to be written to the target platform. Based on authentication of the meta-data, the management controller can copy the SMM code injection capsule into memory for utilization by the SMM.

In operation 2, the SMM code injection capsule can cause copying of the microcode to memory of the management controller or host flash memory and a write to MSR 0x79 (or other register or memory address) with an address pointing to an address of the microcode capsule (e.g., microcode firmware volume (FV) image) in memory of the management controller or host flash memory. In response to writing to the register, the processor cause execute the microcode without an OS agent deploying the microcode.

During operations 1 and 2, management controller can update an event log with a status of activities, as described earlier.

FIG. 7C shows a system with the microcode update flow. Operation 1 can be similar to that of operation 1 described with respect to FIG. 7A. In operation 2, based on verification and storage of the microcode, the management controller can issue an SMI to the processor, e.g., trigger a general-purpose input/output (GPIO) pin or other input. The SMI can cause the processor to write a pointer to microcode in management controller memory or host flash in a register or memory region. In response to writing to the register or memory region, the processor can execute the microcode without an OS agent deploying the microcode. During operations 1 and 2, management controller can update an event log with a status of activities, as described earlier.

FIG. 7D shows a system that performs microcode updating. After operations described with respect to FIGS. 7A to 7C to copy microcode to management controller memory or host flash complete, if the processor supports microcode update staging, the management controller can copy the microcode in the processor microcode staging area (e.g., processor static random access memory (SRAM)) using staging interface (e.g., GPIO or other interface). To ensure the microcode is authentic, the processor can perform a check of whether a header value of the microcode matches a hash of the microcode (or checksum value or CRC value) prior to executing the microcode. Staging the microcode and authenticating the microcode prior to calling for the processor to execute the microcode based on a pointer in a register or memory region can reduce a time to activate the microcode as the processor has a copy and can commence or even complete the authentication of the microcode. During operations 1 and 2, management controller can update an event log with a status of activities, as described earlier.

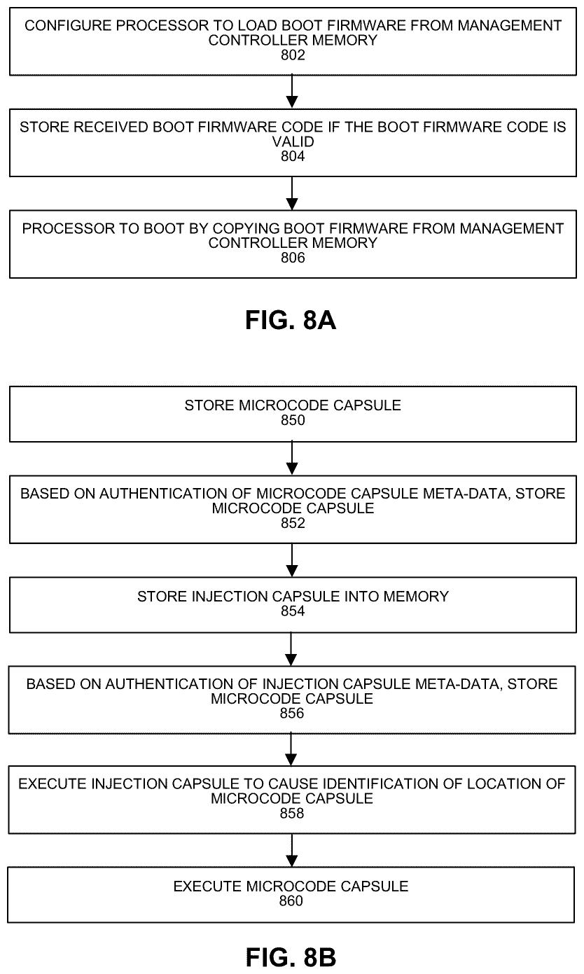

FIG. 8A depicts an example process. The process can be performed by a processor, management controller, and/or other circuitry in some examples. At 802, a processor can be configured to load a boot firmware image from memory of a management controller, instead of from a non-volatile memory device. At 804, based on receipt of a boot firmware image, a management controller can determine if the boot firmware image is valid or invalid. Based on the boot firmware image being valid, the management controller can cause storage of the boot firmware image into memory of the management controller. At 806, a processor can load the boot firmware image from memory of the management controller and perform a boot operation.

FIG. 8B depicts an example process. The process can be performed by a processor, management controller, and/or other circuitry in some examples. At 850, a microcode capsule and meta-data can be received by the management controller. A microcode capsule can include boot firmware and/or microcode. At 852, based on authentication of the meta-data, the management controller can copy a firmware image to management controller memory or host flash. At 854, a code injection capsule and meta-data can be received by the management controller. At 856, based on verification of the meta-data, the management controller can copy the code injection capsule to management controller memory or host flash. At 858, the processor can execute the code injection capsule, which causes a write to a memory region or register with an address pointing to an address of the microcode capsule. At 860, in response to writing to the memory region or register, the processor can execute the microcode without an OS agent deploying the microcode.

FIG. 9 depicts a system. In some examples, boot firmware and/or microcode can be updated or rolled back using a memory of management controller 944, as described herein. System 900 includes processor 910, which provides processing, operation management, and execution of instructions for system 900. Processor 910 can include any type of microprocessor, central processing unit (CPU), graphics processing unit (GPU), XPU, processing core, or other processing hardware to provide processing for system 900, or a combination of processors. An XPU can include one or more of: a CPU, a graphics processing unit (GPU), general purpose GPU (GPGPU), and/or other processing units (e.g., accelerators or programmable or fixed function FPGAs). Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, accelerators 942, management controller 944. Interface 912 represents an interface circuit, which can be a standalone component or integrated onto a processor die. Where present, graphics interface 940 interfaces to graphics components for providing a visual display to a user of system 900. In one example, graphics interface 940 can drive a display that provides an output to a user. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a programmable or fixed function offload engine that can be accessed or used by a processor 910. For example, an accelerator among accelerators 942 can provide data compression (DC) capability, cryptography services such as public key encryption (PKE), cipher, hash/authentication capabilities, decryption, or other capabilities or services. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 942 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

Applications 934 and/or processes 936 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others. OS 932 or driver can enable or disable use of lookup modes described with respect to FIG. 5, 6, or 7 by a switch or other packet processing circuitry as well as configure entries for lookup. [ADD firmware and microcode used by RISC processors (e.g., ARM and RISC5)]

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus that operate in a manner consistent at least with Peripheral Component Interconnect express (PCIe), Compute Express Link (CXL), a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 technology to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory. Network interface 950 can receive data from a remote device, which can include storing received data into memory. In some examples, packet processing device or network interface device 950 can refer to one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

In one example, system 900 includes one or more input/output (I/O) interface(s) 960. I/O interface 960 can include one or more interface components through which a user interacts with system 900. Peripheral interface 970 can include any hardware interface not specifically mentioned above. Peripherals refer generally to devices that connect dependently to system 900.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. A non-volatile memory (NVM) device is a memory whose state is determinate even if power is interrupted to the device.

In an example, system 900 can be implemented using interconnected compute sleds of processors, memories, storages, network interfaces, and other components. High speed interconnects can be used based on: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Management controller 944, memory 930, and processor 910 can be implemented as part of a same system on chip, same or different chiplets (e.g., integrated circuits), and/or same or different dies (e.g., silicon on which transistors, diodes, resistors, and other components, are housed as part of an electronic circuit). Communications between devices can take place using a network that provides die-to-die communications; chiplet-to-chiplet communications; chip-to-chip communications; circuit board-to-circuit board communications; and/or package-to-package communications.

In an example, system 900 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: a management controller comprising a memory and a system processor coupled to the management controller, wherein the system processor is to: based on a first configuration, perform a boot operation by a read of first boot firmware code from the memory of the management controller.

Example 2 includes one or more examples, and includes a system on chip (SoC), wherein the SoC comprises the management controller and the system processor.

Example 3 includes one or more examples, and includes a first chiplet and a second chiplet, wherein the first chiplet comprises the management controller and the second chiplet comprises the processor.

Example 4 includes one or more examples, and includes a die, wherein the die comprises the management controller and the processor.

Example 5 includes one or more examples, wherein: based on a second configuration, the system processor is to perform a boot operation by a read of second boot firmware code from a flash memory.

Example 6 includes one or more examples, wherein the system processor comprises one or more of: a central processing unit (CPU), a CPU core, graphics processing unit (GPU), general purpose GPU (GPGPU), or a processor of a network interface device.

Example 7 includes one or more examples, wherein a region of the memory of the management controller is reserved to store the first boot firmware code by a system administrator or orchestrator.

Example 8 includes one or more examples, wherein the first configuration is based on content of a processor accessible register and a memory address of the first boot firmware code.

Example 9 includes one or more examples, wherein the first boot firmware code comprises one or more of: microcode, Basic Input/Output System (BIOS), Universal Extensible Firmware Interface (UEFI), a boot loader, an operating system (OS), or an Authenticated Code Module (ACM).

Example 10 includes one or more examples, wherein the first boot firmware code comprises microcode and the processor is to fetch the microcode before the processor is to invoke code at a reset vector location.

Example 11 includes one or more examples, wherein: the management controller is to receive and store a code injection segment into system memory and the system processor is to execute the code injection segment to copy the first boot firmware code from the memory to the system memory and cause execution of the first boot firmware code from the system memory to update microcode without resetting a central processing unit (CPU).

Example 12 includes one or more examples, wherein: the management controller is to stage the first boot firmware code in memory of the processor prior to the execution of the first boot firmware code from the memory to update the microcode.

Example 13 includes one or more examples, and includes a method comprising: updating a boot firmware code to identify an address in memory of a microcode update and executing the microcode update from the address in memory without resetting a central processing unit (CPU).

Example 14 includes one or more examples, and includes a management controller verifying the microcode update prior to storage of the microcode update starting at the address in the memory.

Example 15 includes one or more examples, and includes executing a code insertion routine to store the microcode update starting at the address in the memory.

Example 16 includes one or more examples, and includes a management controller staging the microcode update in a memory of the CPU prior to executed boot firmware code causing copying of the microcode update to the memory of the CPU.

Example 17 includes one or more examples, and includes a non-transitory computer-readable medium comprising instructions stored thereon, that if executed by at least one processor, cause the least one processor to: based on a first configuration, perform a boot operation by a read of first boot firmware code from memory of a management controller; based on a second configuration, perform a boot operation by a read of second boot firmware code from a flash memory; and based on a command, update the first boot firmware code to identify an address in memory of a microcode update and execute the microcode update from the address in memory without resetting a central processing unit (CPU).

Example 18 includes one or more examples, wherein the first boot firmware code comprises one or more of: microcode, Basic Input/Output System (BIOS), Universal Extensible Firmware Interface (UEFI), a boot loader, an operating system (OS), or an Authenticated Code Module (ACM).

Example 19 includes one or more examples, wherein the at least one processor is to execute a code injection segment to cause identification of a memory address of the first boot firmware code in memory and execution of the first boot firmware code from the memory to update microcode.

Example 20 includes one or more examples, and includes instructions stored thereon, that if executed by at least one processor, cause the least one processor to: cause a management controller to stage the microcode update in a memory of the CPU prior to executed first boot firmware code causing copying of the microcode update to the memory of the CPU.

What is claimed is:

1. An apparatus comprising:
a management controller comprising a memory and
a system processor coupled to the management controller, wherein the system processor is to:
based on a first configuration, perform a boot operation by a read of first boot firmware code from the memory of the management controller.

2. The apparatus of claim 1, comprising a system on chip (SoC), wherein the SoC comprises the management controller and the system processor.

3. The apparatus of claim 1, comprising a first chiplet and a second chiplet, wherein the first chiplet comprises the management controller and the second chiplet comprises the processor.

4. The apparatus of claim 1, comprising a die, wherein the die comprises the management controller and the processor.

5. The apparatus of claim 1, wherein:
based on a second configuration, the system processor is to perform a boot operation by a read of second boot firmware code from a flash memory.

6. The apparatus of claim 1, wherein the system processor comprises one or more of: a central processing unit (CPU), a CPU core, graphics processing unit (GPU), general purpose GPU (GPGPU), or a processor of a network interface device.

7. The apparatus of claim 1, wherein a region of the memory of the management controller is reserved to store the first boot firmware code by a system administrator or orchestrator.

8. The apparatus of claim 1, wherein the first configuration is based on content of a processor accessible register and a memory address of the first boot firmware code.

9. The apparatus of claim 1, wherein the first boot firmware code comprises one or more of: microcode, Basic Input/Output System (BIOS), Universal Extensible Firmware Interface (UEFI), a boot loader, an operating system (OS), or an Authenticated Code Module (ACM).

10. The apparatus of claim 1, wherein the first boot firmware code comprises microcode and the processor is to fetch the microcode before the processor is to invoke code at a reset vector location.

11. The apparatus of claim 1, wherein:
the management controller is to receive and store a code injection segment into system memory and
the system processor is to execute the code injection segment to copy the first boot firmware code from the memory to the system memory and cause execution of the first boot firmware code from the system memory to update microcode without resetting a central processing unit (CPU).

12. The apparatus of claim 11, wherein:
the management controller is to stage the first boot firmware code in memory of the processor prior to the execution of the first boot firmware code from the memory to update the microcode.

13. A method comprising:
updating a boot firmware code to identify an address in memory of a microcode update and
executing the microcode update from the address in memory without resetting a central processing unit (CPU).

14. The method of claim 13, comprising:
a management controller verifying the microcode update prior to storage of the microcode update starting at the address in the memory.

15. The method of claim 13, comprising:
executing a code insertion routine to store the microcode update starting at the address in the memory.

16. The method of claim 13, comprising:
a management controller staging the microcode update in a memory of the CPU prior to executed boot firmware code causing copying of the microcode update to the memory of the CPU.

17. A non-transitory computer-readable medium comprising instructions stored thereon, that if executed by at least one processor, cause the least one processor to:
based on a first configuration, perform a boot operation by a read of first boot firmware code from memory of a management controller;
based on a second configuration, perform a boot operation by a read of second boot firmware code from a flash memory; and
based on a command, update the first boot firmware code to identify an address in memory of a microcode update and execute the microcode update from the address in memory without resetting a central processing unit (CPU).

18. The non-transitory computer-readable medium of claim 17, wherein the first boot firmware code comprises one or more of: microcode, Basic Input/Output System (BIOS), Universal Extensible Firmware Interface (UEFI), a boot loader, an operating system (OS), or an Authenticated Code Module (ACM).

19. The non-transitory computer-readable medium of claim 17, wherein the at least one processor is to execute a code injection segment to cause identification of a memory address of the first boot firmware code in memory and execution of the first boot firmware code from the memory to update microcode.

20. The non-transitory computer-readable medium of claim 17, comprising instructions stored thereon, that if executed by at least one processor, cause the least one processor to:
cause a management controller to stage the microcode update in a memory of the CPU prior to executed first boot firmware code causing copying of the microcode update to the memory of the CPU.
